(19) United States
(12) Patent Application Publication
(10) Pub. No.: US 2015/0258680 A1
(43) Pub. Date: Sep. 17, 2015

(54) AGILE, DRIVEN JOINT WITH THREE DEGREES OF FREEDOM

(71) Applicant: Technische Universitat Munchen, Munchen (DE)

(72) Inventors: Clemens Koessler, Lermoos (AU); Julian Pfaff, Munchen (DE)

(21) Appl. No.: 14/409,929

(22) PCT Filed: May 27, 2013
(86) PCT No.: PCT/EP2013/060835

§ 371 Date: May 26, 2015

(30) Foreign Application Priority Data
Jun. 19, 2012 (DE) 10 2012 105 313.8

(51) Int. Cl. B25J 9/10; B25J 17/02

(52) U.S. Cl. CPC B25J 9/102; B25J 17/0283; Y10S 901/28

(57) ABSTRACT

The invention relates to a joint drive with a joint unit and a curved guide drive. The joint unit comprises a first and a second transmission wheel which are positioned opposite each other. The first and the second transmission wheel can be driven independently of each other by a corresponding first and second actuator, respectively. The joint unit further includes a third transmission wheel which is in contact with the first and the second transmission wheel in a force-fitting manner and which is mounted in a rotatable manner and in a pivotal manner in the rotational direction of the first and the second transmission wheel. The curved guide drive comprises a curved guide in which the joint unit is guided in a rotatable manner about a first axis.

### FIELD OF THE INVENTION

The present invention lies in the field of robotics. More precisely, it concerns a driven joint with three rotatory degrees of freedom and a robot which uses such a driven joint.

### RELATED PRIOR ART

Industrial robots are used in the prior art for a multiplicity of different applications. For example, they are used for automated material processing, e.g. for welding, or for the positioning of objects in manufacture or assembly.

Depending on the field of use, the industrial robots are equipped with different types of joints, which can be present in different numbers. The outermost joint of an industrial robot, which is also designated as “hand joint”, is often provided with an end effector provided specifically for the respective application—for example with a welding tongs or with a gripper. Herein, important functions of such hand joints of industrial robots are two independent bending movements in two different directions (yaw and pitch movement) and a rotational movement about an axis (roll movement). An example of a driven joint connection with only two rotatory degrees of freedom, which can carry out a roll and a pitch movement by means of two transmission wheels and two actuators is disclosed in patent application EP 2 404 713 A1.

A conventional solution for a driven hand joint with three rotatory degrees of freedom for an industrial robot is shown in FIG. 1. Herein, a cardan joint 100, which is also designated as a universal joint, brings about a pitch and/or yaw movement of a flange 102, on which an end effector can be mounted. The cardan joint has a central cross with two axes standing perpendicularly to one another, which are mounted respectively in a corresponding joint section, so that the two joint sections can be pivoted with respect to one another about each of the two axes of the cross, whereby a pitch and a yaw movement of the flange 102 is made possible. A further movement possibility—a roll movement—is made possible by a roll joint 104. All three rotatory degrees of freedom are provided with corresponding actuators, through which the corresponding movements are brought about.

This above-mentioned solution from FIG. 1, however, entails some disadvantages. Owing to the mounting of the cardan joint, the flange 102 must have a certain distance from the intersection point of the yaw and pitch axes. The greater this distance is, the higher is also the torque generated by the end effector mounted on the flange 102, and the actuators for the yaw and the pitch movement must also be correspondingly high-torque. Furthermore, a roll movement under a large yaw or pitch angle involves an increased energy consumption, because all three actuators participate in the movement and one of the two actuators of the cardan joint 100 must rotate particularly quickly at times (so-called “cardan error”). This limits the angular speed of the roll movement in the case of large yaw or pitch angles, which lie close to 90°. Herein, a yaw or pitch angle of 0° corresponds to the position of FIG. 1, in which both axes of the cross of the cardan joint 100 are perpendicular to the axis of the roll joint 104.

A further conventional construction of a hand joint with three rotatory degrees of freedom is illustrated in FIG. 2. FIG. 2 shows a first and a second roll joint 106, 110 and a pitch joint 108, which can be provided with a corresponding actuator, so that the flange 102 can be moved in accordance with the joints about a first roll axis 112, about a pitch axis 114 and about a second roll axis 116. This solution has the advantage that the flange 102 can also be rolled in the case of a large pitch angle—for example of 90°—by means of the second roll joint 110 independently of the first roll joint 106 and the pitch joint 108. In this solution, too, the flange 102 can not be arranged in the immediate vicinity of the pitch axis 114, because the second roll joint 110 is still interposed. In order to be able to apply the necessary torque for the pitch movement of the flange 102—and hence of the end effector—the actuator for the pitch joint 108 must be of accordingly high-torque design. A further disadvantage is that with a pitch angle of 0° (position of FIG. 2), the first and the second roll axis 112 and 116 lie one over another and therefore a singularity is present, which has an unfavourable effect on the programming. In this position, for a pitch movement of the flange 102 into a particular direction, it can be necessary to firstly rotate the flange 102 about 90° about the first roll axis 112, before the desired pitch movement about the pitch axis 114 can be carried out. This can sometimes require very high rotation speeds about the first roll axis 112.

### SUMMARY OF THE INVENTION

It is an aim of the invention to indicate a joint drive with three rotatory degrees of freedom, which overcomes the above-mentioned disadvantages.

A problem underlying the present invention is in particular to provide a joint drive which has at least some of the following characteristics:
a compact structural shape with an advantageous arrangement of the kinematic chain,
no singularity in a central position of the working range,
an increased positioning accuracy in pitch and roll movements,
a large pivoting range for yaw and pitch movements,
suitability for operation with comparatively low-torque actuators,
pitch, yaw and roll movements can be carried out directly, without a previous rotation about another axis being necessary for this,
suitability for a comparatively force- and energy-efficient operation and
comparatively small liability to wear.

This problem is solved by a joint drive according to claim 1. Advantageous further developments are given in the dependent claims.

The joint drive according to the invention comprises a joint unit with a first and a second transmission wheel, which are positioned opposite each other, wherein the first and the second transmission wheel can be driven independently of each other by a corresponding first and second actuator, respectively. The joint unit further includes a third transmission wheel, which is in contact with the first and the second transmission wheel in a force-fitting manner and which is mounted in a rotatable manner and in a pivotal manner in the rotational direction of the first and the second transmission wheel. Furthermore, the joint drive according to the invention comprises a curved guide drive with a curved guide in which the joint unit is guided in a rotatable manner about a first axis. This joint drive can form, for example, the hand joint of an industrial robot, wherein an end effector—such as for example a welding tongs—can be rigidly mounted on the third transmission wheel of the joint drive. The joint drive according to the invention is suitable for carrying out a yaw, a pitch and a roll movement of the third transmission wheel and therefore also a yaw, a pitch and a roll movement of an end effector connected, if applicable, with the third transmission wheel.

The pitch and the roll movement of the third transmission wheel are made possible by the joint unit. Owing to the fact that the first and the second transmission wheel can be driven independently of one another by the first or respectively the second actuator, their rotational directions and rotational speeds can be set independently of one another. Since the third transmission wheel is mounted in a rotatable manner and in a pivotal manner in the rotational direction of the first and of the second transmission wheel, and furthermore is in contact with the first and the second transmission wheel in a force-fitting manner, it can carry out a rotational movement about its own axis (roll movement) and/or a pivotal movement in the rotational direction of the first and/or second transmission wheel (pitch movement) as a function of the rotational direction and the rotational speed of the first and of the second transmission wheel. “Being in contact in a force-fitting manner” means in this context that a force transmission takes place, so that the third transmission wheel is driven or respectively moved by the first and the second transmission wheel. In particular, “being in contact in a force-fitting manner” can mean that the transmission wheels are in engagement with one another when the transmission wheels are formed by toothed wheels.

For the functional capability of the present invention, it is not necessary that the respective transmission wheels can assume said force-fitting contact on their entire circumference. For example, the transmission wheels can be formed by toothed wheels, which only have teeth on a particular section of their circumference. Depending on the length of these sections, the roll movement can then be restricted to a particular angular range.

A pure roll movement of the third transmission wheel is carried out when the first and the second transmission wheel rotate with the same circumferential speed in opposite directions. A pure pitch movement, on the other hand, is carried out when the first and the second transmission wheel rotate with the same circumferential speed in the same direction. The expressions “rotate in the same direction” and “rotate in the opposite direction” are to be understood in the present description to mean that the two transmission wheels, positioned opposite each other, rotate in the same direction or respectively in the opposite direction. The rotations here do not necessarily have to point in exactly the same or exactly the opposite direction, because positioning- and manufacturing tolerances can also be present, which are included in the formulation. Deviations in direction here are preferably ≦10°, particularly preferably ≦5°, especially ≦1°.

As described above, the roll and the pitch movements are brought about in the joint unit by means of the first and the second actuator together. Herein, it is possible that the roll and the pitch movements are carried out on the one hand separately and successively, or on the other hand simultaneously. When the actuators are operated with different drive speeds and when the first and the second transmission wheel have the same circumference, the first and the second transmission wheel rotate with a different circumferential speed, so that the third transmission wheel carries out a roll and a pitch movement simultaneously.

In the joint drive according to the invention, the yaw movement is made possible by means of the curved guide drive, which comprises a curved guide. As the joint unit in the curved guide is guided in a rotatable manner about the first axis, the joint unit—and together with it also the third transmission wheel—carries out a movement about the first axis, when the curved guide drive drives the curved guide. This movement corresponds to the above-mentioned yaw movement.

The combination of a joint unit with a curved guide drive in the joint drive according to the invention offers substantial advantages compared with the solutions of the prior art for joint drives with three rotatory degrees of freedom for industrial robots.

For example, it becomes possible to mount an end effector very closely to the second axis. Thereby, the torque of the actuators which is to be applied can be reduced for the pitch movement, so that these actuators have to be less powerful, whereby the costs and the energy expenditure necessary for the drive can be reduced. Furthermore, it becomes possible to carry out a roll movement also with pitch angles up to 90° and beyond 90° without difficulty. A simultaneous movement or rotation about other axes is not necessary here. Furthermore, a pivotal movement from the centre of the working range can be carried out directly, without a preceding rotation about another axis having to take place for this. For this, the curved guide drive and the joint drive can be used individually or both drives can be used in combination. Since both the pitch movement and also the roll movement are carried out jointly through two actuators, the torques of which are summated, it is possible to use actuators which are only designed for comparatively low torques. Furthermore, an error of the first or second actuator only has half an effect on the roll or respectively pitch angle, so that the positioning accuracy is increased compared with a solution in which one actuator is used for one movement. Furthermore, the torque necessary for the pitch and the roll movement is distributed to the first and the second actuator, which transmit their respective torque portion to the third transmission wheel by means of the first or respectively second transmission wheel. Thereby, the transmission wheels only have to be designed for comparatively small forces, so that a comparatively small and light construction is made possible, and in addition the wear is reduced. The joint drive according to the invention can be further realized by a comparatively compact structural form and does not contain any singularity in a central position of the working range which has an unfavourable effect on the programming.

In the joint drive according to the invention, the first and the second transmission wheel are preferably mounted in a rotatable manner about a second axis, so that the third transmission wheel is pivotable about the second axis in the rotational direction of the first and the second transmission wheel.

“Axis” in the present patent application does not mean any actual, mechanical axes, which form a functional part of a device, but rather imaginary lines for the description of positional relationships.

The first and the second transmission wheel are driven by the respective actuator and rotate according to the preferred embodiment about the second axis, so that the pitch movement of the third transmission wheel takes place perpendicularly to the second axis.

The term “perpendicular”—just as all other terms used in the present description to describe the arrangement or position—is not to be understood here as “exactly perpendicular”, but rather as “substantially perpendicular” or “approximately perpendicular”, so that manufacturing and assembly tolerances and insignificant deviations are not excluded. Deviations from an exactly perpendicular arrangement here are preferably ≦10°, particularly preferably ≦5° and especially ≦1°.

Preferably, the third transmission wheel is mounted in a rotatable manner about a third axis, which is arranged perpendicularly to the second axis. The second axis is again preferably perpendicular to the first axis. Preferably, the first, the second and the third axis are arranged such that they intersect in a centre. This centre can for example be a point or else a region with a certain extent, the size of which can depend on the manufacturing and assembly tolerances of the joint drive. For the controlling and for the programming of the joint drive, it is advantageous if the axes intersect in a centre.

A possibility for the embodiment of the transmission wheels consists in using bevel wheels respectively for the first, the second and the third transmission wheels. Here, the teeth of the first and of the second bevel wheel are respectively in engagement with the teeth of the third bevel wheel, so that the third bevel wheel carries out a pitch and/or roll movement in response to a rotation of the first and/or second bevel wheel.

Alternatively, the first and the second transmission wheel can also be embodied as spur wheels and the third transmission wheel as a crown wheel. This arrangement has the further advantage that the first and the second spur wheel can be driven indirectly by means of a corresponding further spur wheel, wherein the further spur wheel would be situated in the plane of the corresponding first or respectively second spur wheel and would be in engagement with the corresponding first or respectively second spur wheel. In this way, the actuators can be moved in the direction of the third axis, whereby the moment of inertia of the joint drive can be reduced. This is advantageous, when the joint drive is moved by another driven joint, because the corresponding actuator has to apply a smaller torque.

The curved guide of the curved guide drive can be driven for example by means of toothed wheels and/or belts.

Preferably, the first and/or the second actuator, which together bring about the pitch and roll movement, comprise servomotors.

In an advantageous further development, the third transmission wheel is connected rigidly with a flange, in particular the flange can be formed on the third transmission wheel itself. The flange can be used for the receiving or mounting of an end effector.

It is furthermore advantageous if the curved guide has the form of a segment of a circle. The curved guide can then be driven by means of the curved guide drive such that it moves on a circular path about the first axis. In order to cover a large angular range for the yaw movement, the segment of the circle has an arc length preferably of ≧π/2, particularly preferably of ≧π, especially of ≧9π/8. A large segment of a circle generally has the advantage that more space is available for the mounting of the joint unit, and the rigidity and the stability of the joint drive are increased.

Preferably, however, the segment of a circle is not a closed circular arc, but rather contains an opening which offers space for the pitch movement. In this embodiment, the segment of a circle has an arc length of preferably ≦2π, particularly preferably of ≦7π/4, especially of ≦5π/3.

Furthermore, the curved guide is preferably embodied such that it can rotate the joint unit in an angular range of preferably ≧90°, particularly preferably of ≧180°, about the first axis.

Preferably, the joint drive also comprises a control unit, which is suitable for activating the first or respectively the second actuator such that the third transmission wheel carries out a rotation about its own axis and/or a pivotal movement in the rotational direction of the first and of the second transmission wheel as a function of the rotational direction and/or of the rotational speed of the first and of the second actuator. Herein, a pivotal movement of the third transmission wheel in the rotational direction of the first and of the second transmission wheel” can mean in particular that the third transmission wheel carries out a pivotal movement about the second axis. This means that the control unit brings about the roll and/or the pitch movement of the third transmission wheel or respectively of an end effector connected therewith, through a corresponding activation of the first and of the second actuator.

A further advantageous further development consists of a robot which comprises a joint drive according to the invention. The joint drive can form, for example, the hand joint of the robot, which is arranged after an elbow joint in the kinematic chain. The joint drive can be connected rigidly here with an end effector—for example with a welding tongs.

### BRIEF DESCRIPTION OF THE FIGURES

Further advantages and features of the invention will become apparent from the following description, in which the invention is explained in further detail by means of a preferred example embodiment, with reference to the enclosed drawings. Therein:

FIG. 1 shows a schematic drawing of a conventional joint drive with three rotatory degrees of freedom with a roll joint and with a cardan joint,

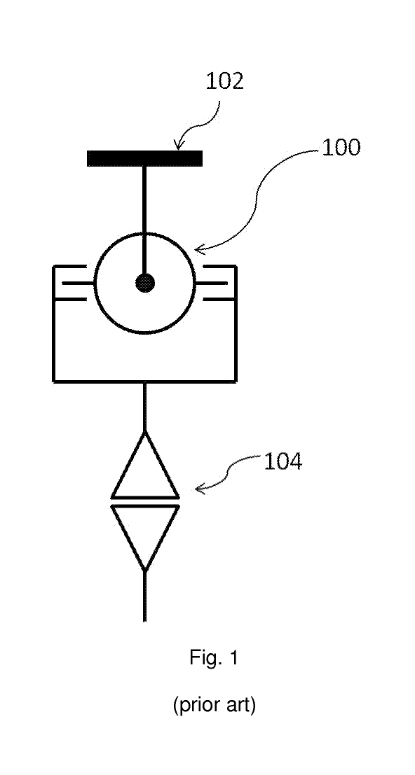

FIG. 2 shows a schematic drawing of a conventional joint drive with three rotatory degrees of freedom with two roll joints and with a pitch joint,

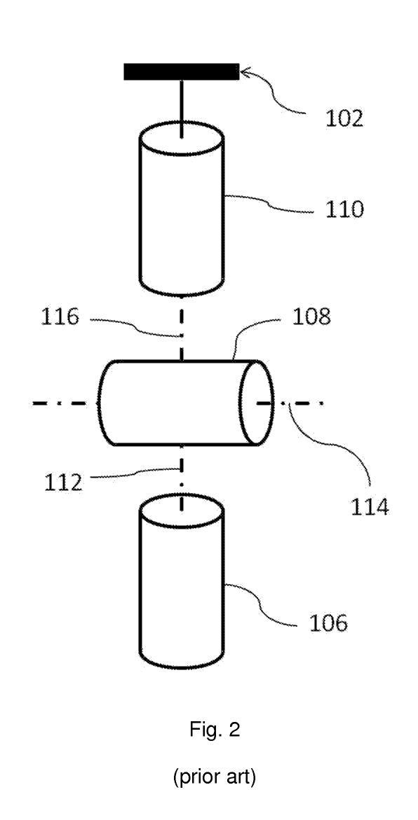

FIG. 3 shows a perspective view of a preferred embodiment of the joint drive according to the invention,

FIG. 4 shows a schematic drawing of the curved guide drive and of the joint unit,

FIG. 5 shows a perspective view of the joint unit,

FIG. 6 shows a figure to explain the mode of operation of the joint unit, and

FIG. 7 shows a figure of the relative arrangement of the rotation axes of the joint drive.

### DESCRIPTION OF THE PREFERRED EMBODIMENT

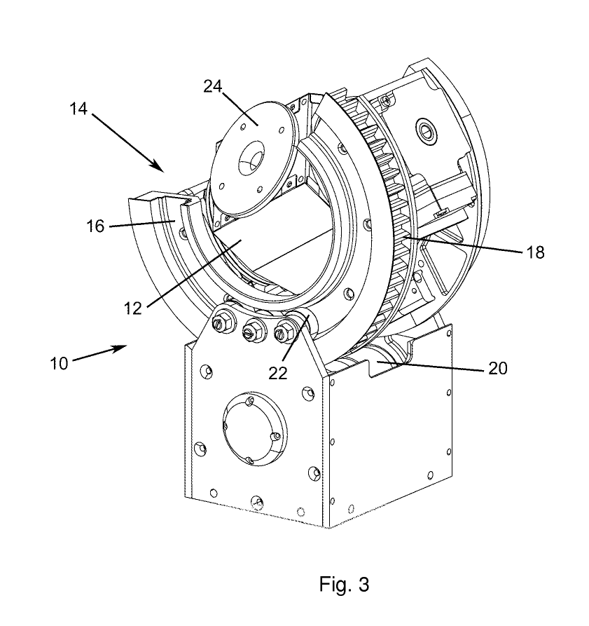

FIG. 3 shows a preferred embodiment of a joint drive 10 according to the invention, which comprises a joint unit 12 and a curved guide drive 14 with a curved guide 16. The curved guide 16 comprises a toothing 18, and the curved guide drive 14 comprises furthermore a toothed wheel drive 20. The curved guide 16 is guided over runners 22 in the curved guide drive 14. The joint unit 12 contains a flange 24 for receiving an end effector.

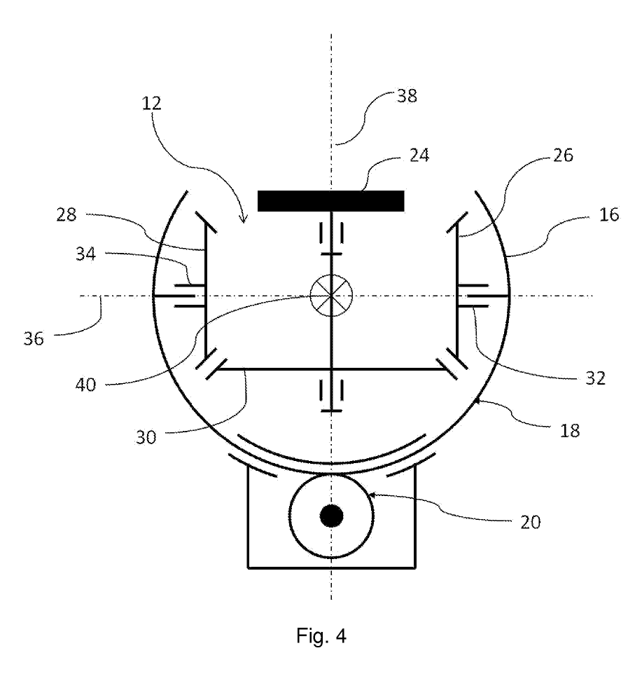

The mode of operation of the curved guide drive 14 is explained below by means of FIG. 4, which shows a schematic drawing of the curved guide drive 14 and the joint unit 12. FIG. 4 shows, furthermore, a first transmission wheel 26 and a second transmission wheel 28, which are positioned opposite each other, and a third transmission wheel 30, which is perpendicular to the first and to the second transmission wheel 26 and 28. The first transmission wheel 26 is mounted in a rotatable manner in a first mounting 32, and the second transmission wheel 28 is mounted in a rotatable manner in a second mounting 34. The first and the second transmission wheel 26 and 28 are arranged in a rotatable manner about a second axis 36, which is perpendicular to a third axis 38, about which the third transmission wheel 30 is rotatable. The flange 24 and the third transmission wheel 30 are connected rigidly to one another and mounted in a pivotal manner together about the second axis 36. The third axis 38 is co-pivoted as rotation axis of the third transmission wheel 30 on a pivotal movement thereof accordingly—perpendicularly to the second axis 36. A first axis 40 runs through the centre of the curved guide 16 perpendicularly to the plane of the drawing, about which first axis the curved guide 16 can be rotated. This movement is imparted by the toothed wheel drive 20. As the toothed wheel drive 20 is in engagement with the toothing 18 of the curved guide 16, the curved guide 16 is moved on a circular path about the first axis 40 running through the centre of the circular path in response to a driving rotary movement of the toothed wheel drive 20. The joint unit 12, and with the latter the second and the third axis 36, 38, are co-moved accordingly on the movement of the curved guide 16.

The position of the joint drive 10 illustrated in FIG. 4 corresponds to the centre of the working range. In this position, all three axes are perpendicular to one another, wherein the second and the third axis 36, 38 lie in the plane of the drawing and the first axis 40 stands perpendicularly to the plane of the drawing. From this position, the flange 24 can carry out a roll movement about the third axis 38, a pitch movement perpendicularly to the plane of the drawing (i.e. about the second axis 36) and/or a yaw movement in the plane of the drawing.

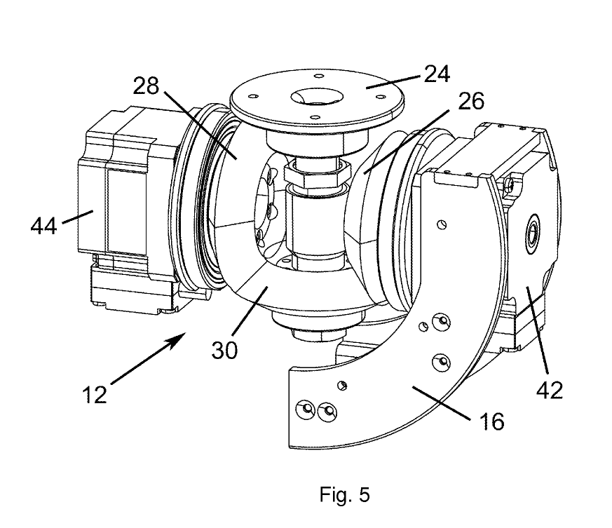

FIG. 5 shows a perspective view of the joint unit 12 and of a section of the curved guide 16. It can be seen in FIG. 5 that a first or respectively a second actuator 42 and 44 are rigidly connected with the first and the second transmission wheel 26, 28, so that the first and the second transmission wheel 26, 28 can be driven independently of one another by rotations of the first and of the second actuator 42, 44. The transmission wheels 26, 28 in FIG. 5 are bevel wheels, the teeth of which are not illustrated. The first and the second transmission wheel 26, 28 are in engagement with the third transmission wheel 30, which is rigidly connected with the flange 24.

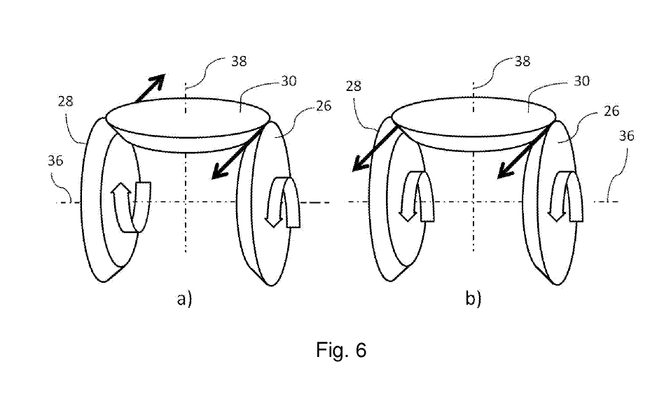

The mode of operation of the joint unit 12 is illustrated in FIG. 6. In FIG. 6 it is shown that the first and the second transmission wheel 26, 28 are arranged in a rotatable manner about the second axis 36 and the two transmission wheels 26, 28 are in engagement with the third transmission wheel 30, which is arranged in a rotatable manner about the third axis 38. In FIG. 6 a) the first and the second transmission wheel 26, 28 rotate in opposite directions, which leads to a roll movement of the third transmission wheel 30. In FIG. 6 b) the first and the second transmission wheel 26 and 28 rotate in the same direction, which leads to a pitch movement of the third transmission wheel 30.

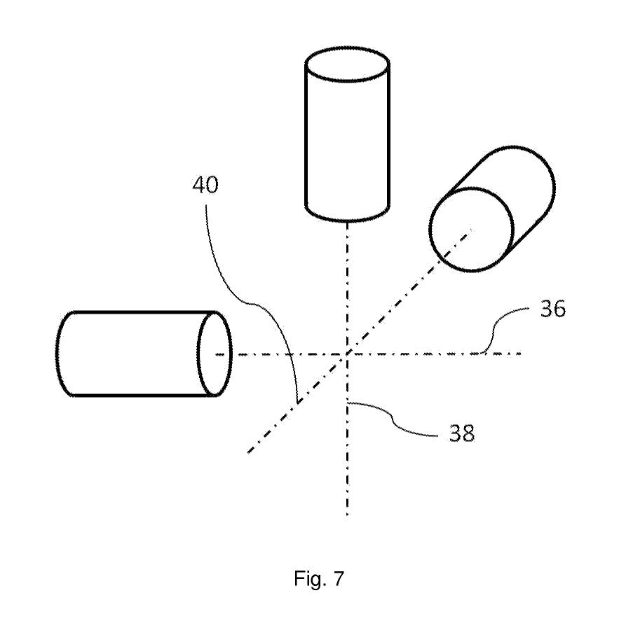

FIG. 7 shows the first axis 40, the second axis 36 and the third axis 38 in the basic position of the joint drive 10 in the centre of the working range. The third axis 38 is stationary with respect to the third transmission wheel 30 (not shown), which in turn can be connected rigidly with an end effector. The movement of the third axis 38 therefore corresponds to the movement of the end effector. The first axis 40 is stationary with respect to the joint drive 10 (not shown) and does not change its position either as a result of a movement of the toothed wheel drive 20 (not shown) or as a result of an operation of the first and of the second actuator 42, 44 (not shown). When the first and the second actuator 42, 44 rotate with the same speed in opposite directions, this leads to a pure roll movement of the third transmission wheel 30 about the third axis 38. A movement about the first or second axis 40 and 36 is not carried out here, and the position of the third axis 38 remains unchanged. When the first and the second actuator 42 and 44 rotate at the same speed in the same direction, this leads to a pure pitch movement of the third transmission wheel 30, which is carried out on a circular path about the second axis 36. The position of the third axis 38 changes here, whereas the positions of the first and of the second axis 40 and 36 remain unchanged.

The movement of the curved guide 16 (not shown) by means of the toothed wheel drive 20 (not shown) leads to a rotation of the joint unit 12 (not shown) about the first axis 40. Here, the second axis 36, which is stationary with respect to the curved guide 16, is pivoted accordingly. The movement of the third axis 38 depends here on the pitch angle, which indicates the deviation of the third axis 38 from its position illustrated in FIG. 7, in which the pitch angle is 0°. With a pitch angle of 90°, the first and the third axis 40, 38 coincide, so that with a yaw movement only the second axis 36, but not the third axis 38, changes its position. In this case, a singularity is present, for which the roll movement and the yaw movement of the third transmission wheel 30 coincide, and therefore only two independent movements (pitching and rolling) can be carried out. However, this singularity is of minor importance in practice, because it typically lies at the edge of the working range.

Although a preferred example embodiment has been presented and detailed in the drawings and in the preceding description, this is to be regarded as being purely by way of example and not restricting the invention. It is pointed out that only the preferred example embodiment was illustrated and described in detail and amendments and modifications which currently and in the future lie in the scope of the invention are to be protected. The features which are shown can be of importance in any desired combinations.

### LIST OF REFERENCE NUMBERS

10 joint drive
12 joint unit
14 curved guide drive
16 curved guide
18 toothing
20 toothed wheel drive
22 runners
24 flange
26 first transmission wheel
28 second transmission wheel
30 third transmission wheel
32 first mounting
34 second mounting
36 second axis
38 third axis
40 first axis
42 first actuator
44 second actuator
100 cardan joint
102 flange
104 roll joint
106 first roll joint
108 pitch joint
110 second roll joint
112 first roll axis
114 pitch axis
116 second roll axis

1. A joint drive comprising:
a joint unit with a first and a second transmission wheel, which are positioned opposite each other, wherein the first and the second transmission wheel can be driven independently of each other by a corresponding first and second actuator respectively, and with a third transmission wheel, which is in contact with the first and the second transmission wheel in a force-fitting manner and which is mounted in a rotatable manner and in a pivotal manner in the rotational direction of the first and the second transmission wheel, and
a curved guide drive with a curved guide, in which the joint unit is guided in a rotatable manner about a first axis.

2. The joint drive according to claim 1, in which the first and the second transmission wheel are mounted in a rotatable manner about a second axis, and in which the third transmission wheel is able to be pivoted about the second axis in the rotational direction of the first and of the second transmission wheel.

3. The joint drive according to claim 2, in which the third transmission wheel is mounted in a rotatable manner about a third axis, and the third axis is arranged perpendicularly to the second axis.

4. The joint drive according to claim 2, in which the second axis is arranged perpendicularly to the first axis.

5. The joint drive according to claim 3, in which the first, the second and the third axis intersect in a centre.

6. The joint drive according to claim 1, in which the first, the second and the third transmission wheel are bevel wheels.

7. The joint drive according to claim 1, in which the first and the second transmission wheel are spur wheels and in which the third transmission wheel is a crown wheel.

8. The joint drive according to claim 1, in which the curved guide of the curved guide drive is able to be driven with toothed wheels and/or belts.

9. The joint drive according to claim 1, in which the first and/or the second actuator is a servomotor.

10. The joint drive according to claim 1, in which the third transmission wheel is rigidly connected with a flange or comprises a flange, which is suitable for a rigid connection with an end effector.

11. The joint drive according to claim 1, in which the curved guide has the form of a segment of a circle, wherein the segment of a circle has an arc length ≧π/2.

12. The joint drive according to claim 1, in which the curved guide is suitable to rotate the joint unit in an angular range about the first axis, which is ≧90°.

13. The joint drive according to claim 1, which furthermore comprises a control unit, which is suitable to activate the first or respectively the second actuator such that the third transmission wheel carries out a rotation about its own axis and/or a pivotal movement in the rotational direction of the first and of the second transmission wheel depending of the rotational direction and/or of the rotational speed of the first and of the second actuator.

14. A robot comprising a joint drive said joint drive comprising:
a joint unit with a first and a second transmission wheel, which are positioned opposite each other, wherein the first and the second transmission wheel can be driven independently of each other by a corresponding first and second actuator respectively, and with a third transmission wheel, which is in contact with the first and the second transmission wheel in a force-fitting manner and which is mounted in a rotatable manner and in a pivotal manner in the rotational direction of the first and the second transmission wheel; and
a curved guide drive with a curved guide, in which the joint unit is guided in a rotatable manner about a first axis.

15. The joint drive according to claim 11, in which the curved guide has the form of a segment of a circle, wherein the segment of the circle has an arc length ≧π.

16. The joint drive according to claim 11, in which the curved guide has the form of a segment of a circle, wherein the segment of the circle has an arc length ≦7π/4.

17. The joint drive according to claim 12, in which the curved guide is suitable to rotate the joint unit in an angular range about the first axis which is ≧180°.
